(19) United States
(12) Patent Application Publication
(10) Pub. No.: US 2013/0151147 A1
(43) Pub. Date: Jun. 13, 2013

(54) METHOD AND DEVICE FOR AUTOMATICALLY MONITORING ON AN AIRCRAFT AN IDENTIFICATION CODE OF A GROUND STATION OF A NAVIGATION SYSTEM

(71) Applicant: AIRBUS OPERATIONS SAS, Toulouse (FR)

(72) Inventors: Nour-ed-din HOUBERDON, TOULOUSE (FR); Michel COLIN, COLOMIERS (FR)

(73) Assignee: AIRBUS OPERATIONS SAS, Toulouse (FR)

(21) Appl. No.: 13/710,726

(22) Filed: Dec. 11, 2012

(30) Foreign Application Priority Data
Dec. 13, 2011 (FR) 1161520

(51) Int. Cl. G01C 21/20

(52) U.S. Cl. CPC G01C 21/20
USPC 701/514

(57) ABSTRACT

A monitoring device is provided. The monitoring device includes means for verifying whether an identifier received from a ground station of a radionavigation system is among the identifiers of the ground stations situated in a monitoring zone around the current horizontal position of the aircraft.

### CROSS-REFERENCE TO RELATED APPLICATIONS

This application claims priority to French Patent Application No. 11 61520, filed Dec. 13, 2011, which is incorporated herein by reference in its entirety.

### TECHNICAL FIELD

The technical field relates to a method and a device for automatically monitoring aboard an aircraft an identifier of at least one ground station relating to a radionavigation system. Within the framework of the present disclosure, a radionavigation system is of the type comprising a plurality of ground stations, each of which is able to transmit navigation information comprising an identifier (generally defined by a series of two or three letters in Morse code), making it possible to identify the ground station, and positioning data, making it possible to determine information regarding relative positioning (between the aircraft and this ground station).

### BACKGROUND

It is known that an aircraft such as a transport airplane comprises, generally, onboard means relating to several radionavigation systems of this type, which are based on radiofrequency communication between the ground stations (transmitting their identifier as well as the item of information to be processed) and the moving aircraft, and in particular, an onboard radiogoniometer, of ADF type (for “Automatic Direction Finder”), which provides the heading exhibited by the aircraft with respect to a ground station. This radiogoniometer may be used in various flight phases, but it is mainly employed in the cruising and approach phases. The aircraft can include a VHF omnidirectional radio beacon, of VOR type (for “VHF (“Very High Frequency”) Omnidirectional Range”), which makes it possible to ascertain the magnetic bearing (or “VOR bearing”) of the aircraft, and a distance measuring system, of DME type (for “Distance Measuring Equipment”), which makes it possible to ascertain the direct distance between a ground station and the aircraft in motion.

Aboard the aircraft the pilots of the aircraft have means making it possible to select a particular ground station of such a radionavigation system. The item of navigation information transmitted by a selected ground station and received aboard the aircraft therefore comprises in one example a Morse code for identifying the selected ground station. Onboard means convert this Morse code into a digital identifier and provide this digital identifier to display systems, of CDS type (“Cockpit Display System”) in particular, which undertake the display thereof in the flight deck of the aircraft.

These standard radionavigation systems exhibit weaknesses due in particular to the technologies used, as well as to the radiofrequency environment in general.

These weaknesses may lead said systems to provide, at least momentarily, an identifier of a ground station selected by a pilot, which may be erroneous (so that the digital identifier displayed may not be that of the station selected).

Indeed, as a function of the propagation and reception conditions, spurious signals of various natures may impair the decoding of the identifier of the station displayed in the flight deck. The possible causes are various, and can include a spurious reflection, particular atmospheric conditions, particular meteorological conditions and a masking of the signal.

Even if such an error can in principle be detected by the crew, this is not routinely so, and above all it requires monitoring thereby. Such monitoring requires a particular workload and particular attention of the pilots, such as for example making comparisons between the two systems (selection and display) or with other navigation information.

Moreover, this standard solution demands regular monitoring by the pilots of the consistency of the displayed identifier. Therefore, it may be desirable to provide a method and device for automatically monitoring on an aircraft an identifier of a ground station. In addition, other objects, desirable features and characteristics will become apparent from the subsequent summary and detailed description, and the appended claims, taken in conjunction with the accompanying drawings and this background.

### SUMMARY

According to various exemplary embodiments, the present disclosure relates to a method for automatically monitoring, aboard an aircraft, an identifier of at least one ground station relating to a radionavigation system, for example of ADF, VOR or DME type, which comprises a plurality of ground stations, each of which is able to transmit navigation information, an item of navigation information comprising an identifier, which makes it possible to identify the ground station, and positioning data which make it possible to determine information regarding relative positioning (heading, magnetic bearing, distance).

For this purpose, according to the present disclosure, said method is noteworthy in that, for at least one identifier, termed the current identifier, which is received aboard the aircraft from the radionavigation system considered for the current position of the aircraft, the following is carried out in an automatic manner: the current horizontal position of the aircraft is determined; a monitoring zone which is defined on the ground around this current horizontal position is determined; the identifiers of all the ground stations situated in said monitoring zone are extracted from an onboard database, said database containing information relating to the ground stations of said radionavigation system, namely at least the position and the identifier of each of said ground stations; and a check is carried out to verify whether said current identifier (which relates to an item of navigation information received for said current position of the aircraft) is among the identifiers extracted from said database.

Thus, by virtue of the present disclosure, automatic monitoring is carried out based on monitoring the ground stations (or beacons) situated in proximity to the current position of the aircraft (in said monitoring zone), so as to be able to verify whether a so-called current identifier (which relates to an item of navigation information received for said current position of the aircraft) is among the identifiers of these nearby ground stations and to be able to detect (automatically), when this is not the case, an error of this current identifier.

Advantageously, if said current identifier is not among the identifiers extracted from said database: an operator is forewarned, in one example, the pilot or pilots of the aircraft, for example, by a visual and/or audible signal; and/or the one of said identifiers extracted is automatically chosen, and in an additional operation, as auxiliary current (or replacement) identifier, which is then considered to be the proper identifier for the current position of the aircraft.

In one exemplary embodiment, to choose the auxiliary current identifier, the identifiers all being defined by a series of letters, the following operations are carried out: each of the identifiers extracted from said database is compared, letter by letter, with the identifier of a selected ground station; and that one which has the most successive letters in common with this identifier of the selected ground station is retained as auxiliary current identifier.

In this case, if the current identifier is displayed on a screen of the flight deck of the aircraft, in an advantageous manner, said erroneous current identifier is automatically replaced, on said screen, with said auxiliary current identifier thus determined.

In one exemplary embodiment, the following operations are moreover carried out: the current position of the aircraft is received; the position of a plurality of ground stations is received; for each of these ground stations, a positioning datum (heading, magnetic bearing or distance) is determined on the basis of the corresponding position of the ground station and of the current position of the aircraft; each of the positioning data thus determined is compared with a positioning datum received by a selected ground station; (from among these determined positioning data) that one which is equal to the positioning datum received, to within a margin, is chosen; and the identifier corresponding to the ground station exhibiting the chosen positioning datum is extracted from the database, this identifier representing that of said selected ground station.

This exemplary embodiment makes it possible to automatically identify a selected ground station and to automatically retrieve the identifier of this selected ground station. This embodiment can, for example, be used when it is difficult or impossible to determine the identifier in a standard manner.

Furthermore, in another exemplary embodiment, the following operations are carried out: the current position of the aircraft is received; the position of a selected ground station is received; for this selected ground station, a positioning datum (heading, magnetic bearing or distance) is determined on the basis of the position of this selected ground station and of the current position of the aircraft; a positioning datum received from said ground station is compared with the positioning datum thus determined; and if these data differ by more than a margin, an operator is forewarned.

This exemplary embodiment makes it possible to monitor a positioning datum received and thus to detect whether it is erroneous, in one example, with the aim of forewarning the pilots in this case.

The present disclosure also relates to a device for monitoring aboard an aircraft an identifier of at least one ground station relating to a radionavigation system of the type comprising a plurality of ground stations each of which is able to transmit navigation information, an item of navigation information comprising an identifier, making it possible to identify the ground station, and positioning data.

According to the present disclosure, said device is noteworthy in that it comprises: means for acquiring an identifier, termed the current identifier, which is received aboard the aircraft from said radionavigation system for the current position of the aircraft; means for receiving the current horizontal position of the aircraft; means for determining a monitoring zone which is defined on the ground around this current horizontal position; means for extracting from an onboard database, the identifiers of all the ground stations situated in said monitoring zone, said database containing information relating to the ground stations of said radionavigation system, namely at least the position and the identifier of each of said ground stations; and means for verifying whether said current identifier which relates to an item of navigation information received for said current position of the aircraft is among the identifiers extracted from said database.

In one exemplary embodiment, the device in accordance with the present disclosure comprises, moreover: means for forewarning an operator if said current identifier is not among the identifiers extracted from said database; and/or means for automatically selecting one of said extracted identifiers, as auxiliary current identifier, if said current identifier is not among the identifiers extracted from said database; and/or means for automatically replacing, on a screen of the flight deck, an erroneous current identifier with a corresponding auxiliary current identifier.

Furthermore, said device can also comprise: means for determining an identifier, termed the current identifier, on the basis of information received aboard the aircraft from a radionavigation system, for the current position of said aircraft; and means for determining the current horizontal position of the aircraft.

The present disclosure relates, furthermore, to an aircraft, in one example, a transport airplane, which comprises at least one monitoring device such as that aforementioned.

In one exemplary embodiment, said aircraft comprises at one and the same time: a first monitoring device associated with an onboard radiogoniometer of ADF type; a second monitoring device associated with an omnidirectional radio beacon of VOR type; and a third monitoring device associated with a distance measuring system of DME type.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a schematic diagram of a device in accordance with the various teachings of the present disclosure.

FIG. 2 is a schematic view of an aircraft in flight and of ground stations making it possible to explain the operation of a device in accordance with the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

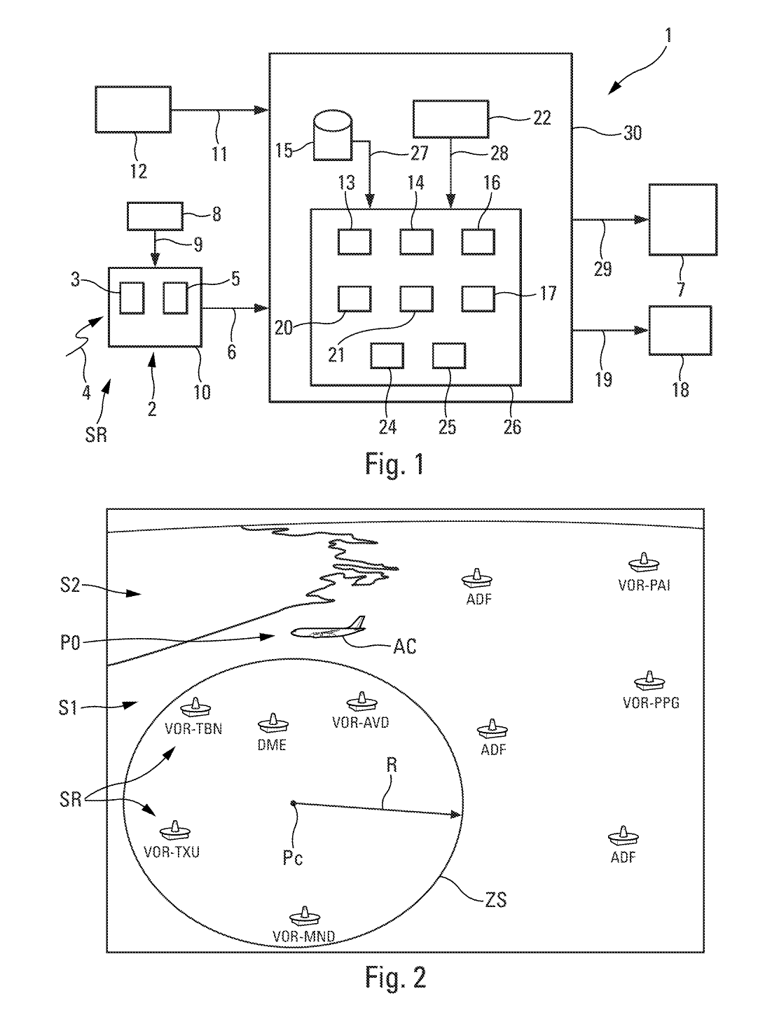

The device 1 in accordance with the present disclosure and represented schematically in FIG. 1 is intended to carry out monitoring aboard an aircraft AC of an identifier of at least one ground station relating to a radionavigation system SR.

Within the framework of the present disclosure, a radionavigation system SR comprises a plurality of ground stations, as is represented in FIG. 2. Each of these ground stations is able to transmit (by radiofrequency) navigation information comprising an identifier (generally defined by a series of two or three letters in Morse code), making it possible to identify the ground station, and positioning data, making it possible to determine information regarding relative positioning (between the aircraft AC and this ground station). The aircraft AC is provided with a unit 2 intended to receive and process the navigation information of such a radionavigation system SR.

This onboard unit 2 comprises in a standard manner: means 3 for acquiring an item of navigation information transmitted by a selected ground station, in radiofrequency form (as illustrated by an arrow 4), this item of navigation information comprising in one example, a Morse code for identifying the selected ground station; means 5 for converting this Morse code into a digital identifier, which is sent to means (in one example, of display) of the aircraft AC; and means 7 for displaying this digital identifier in the flight deck of the aircraft. The means 7 correspond, for example, to a display system of CDS type (“Cockpit Display System”).

This unit 2 comprises, moreover, means 8 which are for example connected by way of a link 9 to an assembly 10 comprising said means 3 and 5 and which allow a pilot to select a particular ground station of the radionavigation system SR.

It is known that an aircraft AC, such as a transport airplane, generally uses several radionavigation systems SR of this type, which are based on radiofrequency communication between the ground stations (transmitting their identifier as well as the item of information to be processed) and the moving aircraft. Hence, it generally comprises a plurality of units 2 each of which is associated with one of these radionavigation systems SR.

Thus, as a function of the radionavigation system SR considered, said means 3 for acquiring an item of navigation information can correspond to: an onboard radiogoniometer, of ADF type (for “Automatic Direction Finder”), which provides the heading that the aircraft AC makes with respect to a ground station. The frequency band used to send the ADF information, as well as the identifier (series of two or three letters in Morse code) of the ground beacon, ranges from about 190 to about 1750 KHz. This radiogoniometer may be used in various flight phases, but it is mainly employed in the cruising and approach phases; or a VHF omnidirectional radio beacon, of VOR type (for “VHF (Very High Frequency) Omnidirectional Range”), which makes it possible to ascertain the magnetic bearing (or “VOR bearing”). The frequency band used to send the VOR information, as well as the identifier (series of two or three letters in Morse code) of the ground beacon, ranges from about 108 to about 118 MHz; or a receiver of a distance measuring system of DME type (for “Distance Measuring Equipment”). Such a distance measuring system makes it possible, by measuring the response time between the signal transmitted by the receiver installed on the aircraft and that returned by a ground station, to ascertain the direct distance between this ground station and the aircraft in motion. The frequency band used to send the DME information, as well as the identifier (series of two or three letters in Morse code) of the ground beacon, ranges from about 962 to about 1213 MHz. More precisely, an onboard interrogator dispatches at random intervals pairs of interrogation pulses to a ground receiver-transmitter which, in its turn, returns pairs of response pulses on the interrogation frequency decreased or increased by about 63 MHz and with a conventional delay of about 50 s.

In FIG. 2, the flight of an aircraft AC, in this instance of a transport airplane, above a terrestrial surface S1 situated in proximity to an expanse of water S2 has been represented in a schematic view. On this terrestrial surface S1 are positioned, by way of illustration, various ground stations, namely: ground stations of VOR type of respective identifiers AVD, TBN, TXU, MND, PAI and PPG; ground stations of ADF type; and a ground station of DME type.

According to the present disclosure, said device 1 which is intended to carry out automatic monitoring, aboard the aircraft AC, of the identifiers of ground stations of a radionavigation system SR, comprises: means (the link 6 for example) for automatically receiving an identifier, termed the current identifier, relating to a radionavigation system SR, which is detected aboard the aircraft AC (by the unit 2) for the latter's current position; means (a link 11 for example) for automatically receiving at least the current horizontal position Pc of the aircraft AC, of onboard standard means 12, for example means of reception of a satellite positioning system, in one example, of GPS or Galileo type. The current horizontal position Pc corresponds to the position of the aircraft AC in the “horizontal” plane of the Earth, that is to say the projection onto said “horizontal” plane of its actual position P0 in space; means 13 for automatically determining a monitoring zone ZS which is defined on the ground around this current horizontal position Pc; means 14 for extracting from an onboard database 15, the identifiers of all the ground stations of said radionavigation system SR, which are situated in said monitoring zone ZS. This database 15 contains information relating to the ground stations of the radionavigation system SR, namely at least the position and the identifier of each of said ground stations; and means 16 for verifying whether said current identifier which relates to an item of navigation information received for said current position Pc of the aircraft AC is among the identifiers extracted from said database 15 by the means 14.

Thus, the device 1 in accordance with the present disclosure carries out automatic monitoring which is based on monitoring the ground stations (or beacons) situated in proximity to the current position Pc of the aircraft AC (in said monitoring zone ZS), so as to verify whether a so-called current identifier (which relates to an item of navigation information received for said current position Pc of the aircraft AC) is among the identifiers of these nearby ground stations and to detect (automatically), if this is not the case, an error of this current identifier.

Said device 1 comprises, moreover, an assembly of means for forewarning an operator, if said current identifier is not among the identifiers extracted from said database 15. This assembly of means comprises means 17 able to control alert means 18 (via a link 19) so that the latter transmit an alert signal, in visual form and/or in audible form, in the flight deck of the aircraft AC. The means 18 can correspond to the display means 7.

Said device 1 comprises, moreover: means 20 for automatically choosing one of said identifiers extracted by the means 14 as auxiliary current identifier, if the means 16 indicate that the current identifier is not among these identifiers; and means 21 for automatically replacing on display means, in one example, on the means 7, the current identifier, if it is displayed and if it has been considered to be erroneous (that is to say not to be among the identifiers extracted from the database 15) by the means 16, with said auxiliary current identifier determined by the means 20.

In one exemplary embodiment, with the aim of automatically choosing the auxiliary current identifier, said means 20 comprise integrated elements (not specifically represented) for respectively: comparing each of the identifiers extracted from the database 15, doing so letter by letter, with the identifier of a selected ground station; and retaining, as auxiliary current identifier, that one which has the most successive letters in common with this identifier of the selected ground station.

By way of illustration, for monitoring applied to a VOR system, it is considered that a station with identifier TBN has been selected (with the aid of the means 8), but that the aircraft AC receives an identifier TBU (therefore exhibiting an erroneous letter) via a VOR receiver (of the unit 2), which is displayed by the means 7. In this case, the means 20 conduct a search through the database 15 for all the VOR stations which are situated in the monitoring zone ZS, for example a circle about 50 NM in radius around the current position Pc of the aircraft AC. They find in the database 15 the identifiers AVD, MND, TBN, TXU, as is represented in FIG. 2. In this case: either, they directly correct TBU with TBN on the display, since they estimate that it is more consistent that it involves this station than TXU, taking into account the flight plan (which is stored in means 22), the current position Pc of the aircraft AC and the range of the ground stations; or, they simply indicate to the pilot (with the aid of the means 18) that the digital identifier TBU is erroneous, since it does not correspond to any of the identifiers of the database 15.

The means 20 can also process the case of two or of three erroneous letters.

In order to optimize the calculation time, said means 20 proceed, generally, by successive sorting with the aid of several filters. By way of illustration, for example, in the database 15 appear the codes AVD, MND, TOU, TXU (first filter). The means 20 process firstly the first letter of the identifiers. They therefore find a “T”. Hence, they will reduce the subsequent analysis to the identifiers TOU and TXU (second filter), and the third filter is thereafter applied to the second letter of the identifiers, and so on and so forth until the last letter of the identifiers.

If the signal is noisy and the process does not operate in the above direction, it is possible to begin with the last letter and to apply the same filtering scheme in the reverse direction.

Generally, the monitoring zone ZS represents a circle of radius R as illustrated in FIG. 2, whose center corresponds to the current horizontal position Pc of the aircraft AC. The radius R can exhibit a predetermined fixed value, for example about 50 NM. It is also conceivable that the value of said radius R can be modified, either manually by a pilot, or automatically. In one example, this value may be refined as a function of parameters, such as the flight plan of the aircraft AC and the range of the ground stations. Of course, the monitoring zone ZS can also exhibit a shape other than a circle.

In addition, in one exemplary embodiment, said device 1 comprises, moreover, means 24 which comprise integrated elements (not represented specifically) for determining, for each of a plurality of ground stations (for example those situated in the monitoring zone ZS), a positioning datum (heading, magnetic bearing, distance) on the basis of the corresponding position of the ground station (extracted from the database 15) and of the current position P0 (in space) of the aircraft AC, for comparing each of the positioning data thus determined with a positioning datum received by a selected ground station (with the aid of the means 8), for choosing (from among these determined positioning data) that one which is equal to the positioning datum received (by the unit 2), to within an error margin, and for extracting from the database 15 the identifier corresponding to the ground station exhibiting the positioning datum thus chosen. This identifier then represents that of said selected ground station.

These means 24 make it possible to automatically identify a selected ground station and to automatically retrieve the identifier of this selected ground station. This embodiment can for example be used when it is impossible to determine the identifier in a standard manner.

Furthermore, in another exemplary embodiment, said device 1 comprises, moreover, monitoring means 25 which comprise integrated elements (not specifically represented) for determining, for a selected ground station (with the aid of the means 8), a positioning datum (heading, magnetic bearing, distance) on the basis of the position of this ground station (extracted from the database 15) and of the current position P0 (in space) of the aircraft AC, for comparing this positioning datum thus determined with the positioning datum received from said selected ground station (via the unit 2) and for forewarning an operator (for example with the aid of the means 18), in the case where these two data differ from one another by more than an error margin.

This exemplary embodiment makes it possible to monitor a positioning datum received from a selected ground station and to detect whether it is erroneous, in one example, with the aim of forewarning the pilots in this case.

In one exemplary embodiment, said means 13, 14, 16, 17, 20, 21, 24, 25 form part of an information processing unit 26 which is connected by links 27 and 28 respectively to said database 15 and to said means 22. This unit 26, as well as said database 15 and said means 22, can form part of a system 30, for example a flight management system of FMS type (“Flight Management System”), which is for example connected by way of links 6, 11, 19 and 29 respectively to said means 10, 12, 18 and 7.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A method for monitoring aboard an aircraft an identifier of at least one ground station relating to a radionavigation system of the type including a plurality of ground stations each of which is able to transmit navigation information, an item of navigation information comprising an identifier, making it possible to identify the ground station, and positioning data which make it possible to determine information regarding relative positioning, and at least one current identifier, which is received aboard the aircraft from said radionavigation system for the current position of the aircraft, the method comprising:
determining a current horizontal position of the aircraft;
determining a monitoring zone which is defined on the ground around this current horizontal position;
extracting the identifiers of all the ground stations situated in the monitoring zone from an onboard database, the database containing at least the position and the identifier of each of the ground stations; and
verifying whether the current identifier which relates to an item of navigation information received for the current position of the aircraft is among the identifiers extracted from the database, and if the current identifier is not among the identifiers extracted from the database, then, automatically selecting one of the identifiers extracted as an auxiliary current identifier.

2. The method as claimed in claim 1, further comprising:
forewarning an operator if the current identifier is not among the identifiers extracted from the database.

3. The method as claimed in claim 1, wherein the identifiers are defined by a series of letters, and automatically selecting the auxiliary current identifier further comprises:
comparing each of the identifiers extracted from the database, letter by letter, with the identifier of a ground station selected by a pilot; and
retaining the one of the identifiers that has the most successive letters in common with the identifier of the ground station selected by the pilot.

4. The method as claimed in claim 1, wherein the current identifier is displayed on a screen, and the current identifier is automatically replaced, on the screen, with the auxiliary current identifier.

5. The method as claimed in claim 1, further comprising:
receiving a current position of the aircraft;
receiving a position of a plurality of ground stations;
determining for each of these ground stations, a positioning datum on the basis of the corresponding position of the ground station extracted from the database and of the current position of the aircraft;
comparing each of the positions of the plurality of ground stations with a positioning datum received by a selected ground station;
selecting from the positions of the plurality of ground stations the ground station that is equal to the positioning datum received within an error margin; and
extracting the identifier corresponding to the ground station exhibiting the chosen positioning datum from the database, this identifier representing that of the selected ground station.

6. The method as claimed in claim 1, further comprising:
receiving a current position of the aircraft;
receiving a position of a selected ground station;
for this selected ground station, determining a positioning datum on the basis of the corresponding position of the ground station extracted from the database and of the current position of the aircraft;
comparing a positioning datum received from the ground station with the determined positioning datum; and
detecting an error if the positioning datum received from the ground station and the determined positioning datum differ by more than an error margin.

7. A device for monitoring aboard an aircraft an identifier of at least one ground station relating to a radionavigation system of the type including a plurality of ground stations each of which is able to transmit navigation information, an item of navigation information including an identifier, making it possible to identify the ground station, and positioning data which make it possible to determine information regarding relative positioning, the device comprising:
a means for acquiring a current identifier, which is received aboard the aircraft from the radionavigation system for a current position of the aircraft;
a means for receiving at least a current horizontal position of the aircraft;
a means for determining a monitoring zone which is defined on a ground around the current horizontal position;
a means for extracting from an onboard database, the identifiers of all the ground stations situated in said monitoring zone, the database containing at least the position and the identifier of each of the ground stations; and
a means for verifying whether the current identifier which relates to an item of navigation information received for the current position of the aircraft is among the identifiers extracted from the database; and
a means for automatically choosing one of the identifiers extracted as auxiliary current identifier, if the current identifier is not among the identifiers extracted from the database.

8. The device as claimed in claim 7, further comprising a means for forewarning an operator, if the current identifier is not among the identifiers extracted from the database.

9. The device as claimed in claim 7, further comprising a means for automatically replacing, on a screen, the current identifier with the auxiliary current identifier.

10. The device as claimed in claim 7, further comprising:
a means for determining an identifier, termed the current identifier, on the basis of information received aboard the aircraft from a radionavigation system for the current horizontal position of the aircraft.

11. An aircraft, comprising:
a means for acquiring an identifier, termed the current identifier, which is received aboard the aircraft from a radionavigation system for a current position of the aircraft;
a means for receiving at least a current horizontal position of the aircraft;
a means for determining a monitoring zone which is defined on a ground around the current horizontal position;
a means for extracting from an onboard database, identifiers of all ground stations situated in the monitoring zone, the database containing at least the position and the identifier of each of the ground stations; and
a means for verifying whether the current identifier which relates to an item of navigation information received for the current position of the aircraft is among the identifiers extracted from the database;
a means for automatically choosing one of the identifiers extracted as auxiliary current identifier, if the current identifier is not among the identifiers extracted from the database; and
a means for forewarning an operator, if the current identifier is not among the identifiers extracted from the database.

12. The aircraft as claimed in claim 11, further comprising:
a first monitoring device associated with an onboard radiogoniometer;
a second monitoring device associated with an omnidirectional radio beacon; and
a third monitoring device associated with a distance measuring system.

13. The aircraft as claimed in claim 11, further comprising a means for automatically replacing, on a screen, the current identifier with the auxiliary current identifier.

14. The aircraft as claimed in claim 11, further comprising:
a means for determining an identifier, termed the current identifier, on the basis of information received aboard the aircraft from a radionavigation system for the current position of the aircraft.
